(19) United States
(12) Patent Application Publication
(10) Pub. No.: US 2015/0034664 A1
(43) Pub. Date: Feb. 5, 2015

(54) BAKING PAN SURFACE COVER INSERT

(71) Applicants: Nanette Boettner Baecher, Birmingham, AL (US); William Warren Kyle, Birmingham, AL (US)

(72) Inventors: Nanette Boettner Baecher, Birmingham, AL (US); William Warren Kyle, Birmingham, AL (US)

(21) Appl. No.: 14/341,072

(22) Filed: Jul. 25, 2014

Related U.S. Application Data
(60) Provisional application No. 61/860,988, filed on Aug. 1, 2013.

(51) Int. Cl. A21B 3/13

(52) U.S. Cl. CPC A21B 3/135
USPC 220/780

(57) ABSTRACT

A flexible heat resistant surface cover for cupcake pans for baking multiple cupcakes or the like. The surface cover overlies the upper surface of the cupcake pan and has multiple aligned form fitting depending annular flanges that engage a portion of the interior surface of each individual cupcake receiving area. The surface cover prevents extraneous batter spillage keeping the cupcake pan clean during and after baking.

This application claims the benefit of U.S. Provisional Application No. 61/860,988, filed Aug. 1, 2013.

### BACKGROUND OF THE INVENTION

1. Technical Field

This invention relates to baking pan inserts specifically inserts for baking multiple cupcakes wherein each of the multiple cake forms are filled with cake batter for baking.

2. Description of Prior Art

Prior art devices of this type have been directed to a variety of different baking pan configurations and inserts; see for example U.S. Pat. Nos. 1,628,885, 4,052,034, 6,412,402, 6,869,059 and U.S. Publication 2006/0102013 A1.

In U.S. Pat. No. 1,628,885 a cover baking pan is disclosed for securing two loaf pans together.

U.S. Pat. No. 4,052,034 claims a baking device insert that divides the interior of the pan into multiple partitioned areas.

U.S. Pat. No. 6,412,402 illustrates an edge marking baking pan having multiple spaced interior crest to add additional edges to the product baked therein.

U.S. Pat. No. 6,869,059 is directed to a muffin baking pan that has a raised perimeter wall that acts as a shield for better air circulation thereabout during baking.

U.S. Publication 2006/0102013 A1 shows a method of cooking a food item having a cooking sheet liner into which the food is placed.

### SUMMARY OF THE INVENTION

A heat resistant clean cover for cupcakes/muffin baking pans that have a plurality of individual cake forms formed therein. The clean cover of the invention extends over the upper surface of the baking pan with multiple annular openings, each with an annularly depending flange aligned for registration engagement with each of the respective cake pans forming a shield thereover and internally thereabout a limited descending portion of each cake pan. The clean cover allows for traditional insert cupcake paper liners in each cake pan, thus keeping the surrounding pan surface clean by protecting it from spillage during filling with batter.

### DESCRIPTION OF THE DRAWINGS

FIG. 1 is a perspective view of the bake pan surface cover of the invention.

FIG. 2 is a front elevational view thereof with portions cut-away.

FIG. 3 is an end elevational view thereof with portions cut-away.

FIG. 4 is a top plan view thereof.

FIG. 5 is a combined composite exploded front elevational view of the baking pan surface cover insert positioned for insertion on and into the cupcake baking pan.

FIG. 6 is an enlarged partial sectional view of a cupcake baking pan with the baking pan surface cover insert positioned thereon.

### DETAILED DESCRIPTION OF THE INVENTION

Referring to FIGS. 1-3 of the drawings, a baking pan surface cover 10 of the invention can be seen having an integral one-piece flexible body member 11 made of heat resistant FDA approved food grade silicone sheet material in a generally rectangular configuration. The body member 11 has oppositely disposed spaced parallel depending front and back edges 13 and 14 and interconnecting respective opposing depending end edges 15 and 16, best seen in FIG. 4 of the drawings.

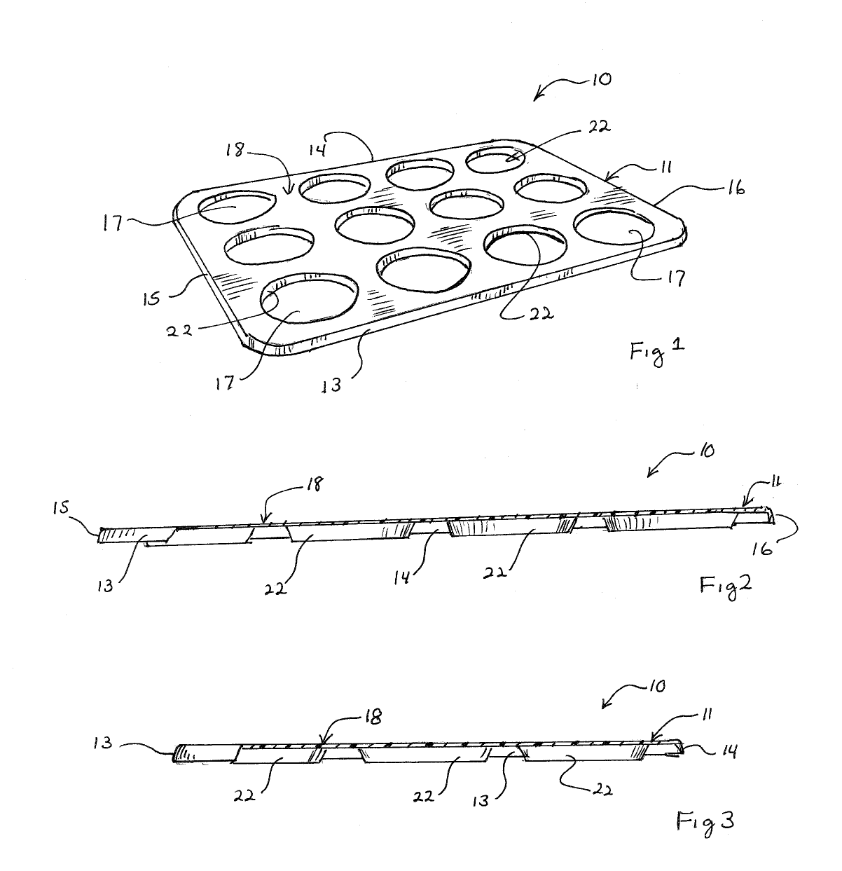

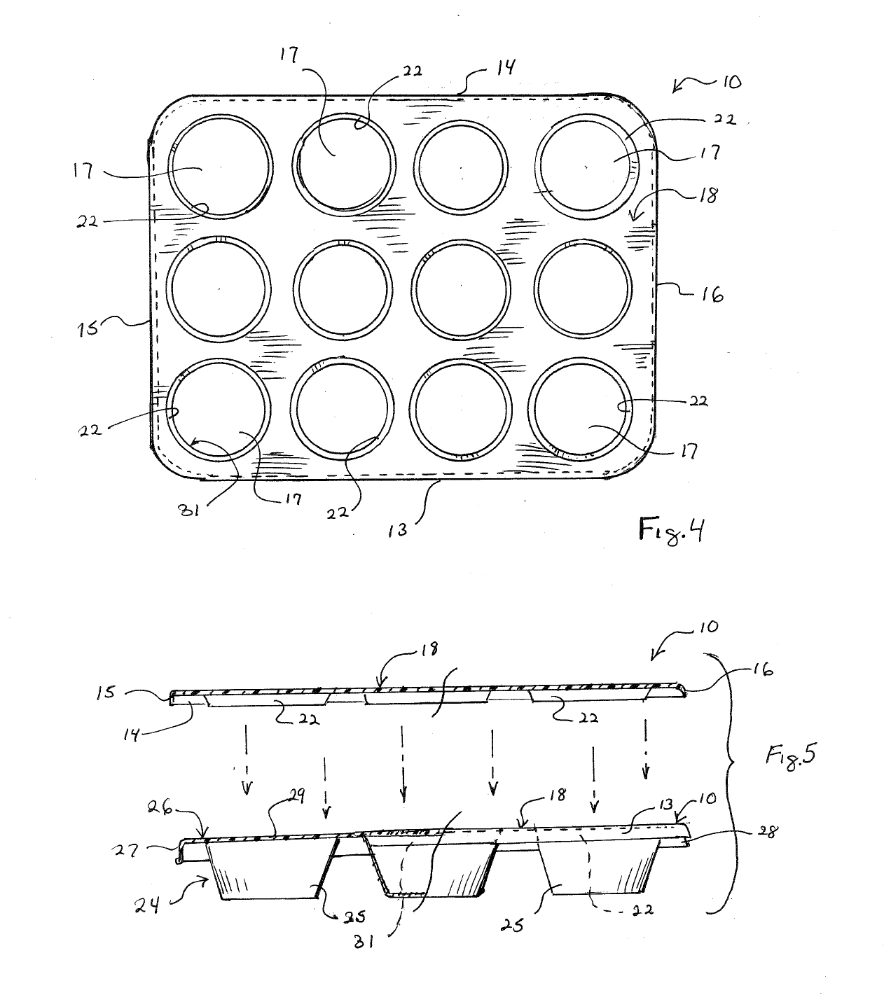

A plurality of annular openings 17 are formed within the upper surface 18 of the body member 11 which, in this example, are in aligned spaced longitudinally extending parallel rows 19, 20 and 21. Each of the annular openings at 17 have an integral depending perimeter flange 22 of a foreshortened fusto conical configuration of a known depending dimension, best seen in FIGS. 2 and 3 of the drawings.

Referring to FIG. 5 of the drawings, the baking pan surface cover 10 can be seen positioned for aligned registration onto a correspondingly aligned cupcake baking pan 24 of a typical commercial available design. The cupcake baking pan 24 therefore is preferably made of metal with a series individual baking cups 25 therein which are interconnected by a continuous planar surface 26 having respective spaced parallel opposing end edges 27 and 28 and front and back depending edges 29 and 30 as will be well known to those skilled in the art.

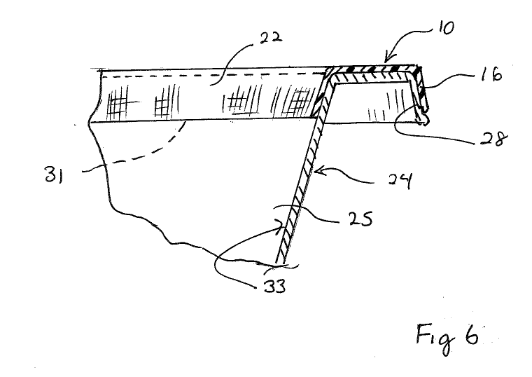

The baking pan surface cover 10 of the invention as hereinbefore described is correspondingly configured dimensionally so as to be placed onto and over the pan 24 surface 26 and registerably partially at 31 within each of the baking cups 25 shown in component split partial, sectional and elevational views in FIGS. 5 and 6 of the drawings.

It will be seen therefore that orientational positioning of the respective depending perimeter edge flanges 22 of each of the annular openings 17 extend partly within each of the corresponding baking cups 25 and thereby position and retain the cover 10 in place on the baking pan 24.

Referring now specifically to FIG. 6 of the drawings, it can be seen that the depending annular flanges 22 are registerably aligned in their respective baking cups 25 by contact against the corresponding baking cups 25 interior continuous descending wall surface 33. It will be apparent therefore that the dimensions of both the annular flanges 22 and the cover's perimeter depending respective surface edge pairs 27-30 can vary depending on design requirements to assure proper engagement and fit in a variety of different cupcake baking pans.

It will also be evident, however, that given the yielding flexibility of the silicone sheet material that a certain adjustability will be afforded to the cover 10 during placement so that minor dimensional differences and engaged pan configurations will be accommodated so as to maintain a proper fit and positioning of the cover on the selected baking pan.

In operation, the baking pan surface cover 10, once applied to the cupcake baking pan 24 or the like will provide for an integral integrated “clean” cover for the surface 26 of the baking pan 24 which is normally exposed to potential cupcake batter, not shown, spillage during filling and therefore eliminate the associated clean-up typical of such spillage once it has been baked on to the cupcake baking pan 24 as is typically currently required.

It will also be apparent that the baking pan surface cover 10 does not interfere with the insertion of the traditional paper or in some instances metal cupcake shells which again are used to assure in practice a clean removal of the baked cupcake from the pan and to with the baked cupcake having a traditional cupcake paper to be removed for consumption, not shown.

It will therefore be seen that the above referred to baking pan surface cover insert 10 of the invention will effectively eliminate the cleaning normally associated and required in an unprotected cupcake pan configuration usage as is encountered by one typically skilled within the art.

It will thus be seen that a new and novel baking pan cover insert for multi-compartmented cupcake/muffin baking pans has been illustrated and described and it will be apparent to those skilled in the art that various changes and modification may be made thereto without departing from the spirit of the invention.

Therefore I claim:

1. A baking pan surface cover for a cupcake pan having a plurality of baking cups formed therein comprises,
an integral one-piece flexible body member,
a plurality of annular openings in said body member,
an annular depending flange extending from each of said respective openings for registration within said respective cupcake pan baking cups.

2. The baking pan surface cover set forth in claim 1 wherein said annular openings are in spaced aligned orientation to one another for registration with said baking cups in said cupcake pan.

3. The baking pan surface cover set forth in claim 1 wherein said annular depending flanges are of a foreshortened fusto-conical configuration.

4. The baking pan surface cover set forth in claim 1 wherein said one-piece flexible body member has oppositely disposed spaced parallel depending front and back integral edges.

5. The baking pan surface cover set forth in claim 1 wherein said one-piece flexible body member is made from heat resistant synthetic silicone resin.

6. The baking pan surface cover set forth in claim 1 wherein said one-piece flexible body member overlies a top surface of said cupcake pan.

7. The baking pan surface cover set forth in claim 1 is self-aligning in said corresponding baking cups formed in said cupcake baking pan.

8. The baking pan surface cover set forth in claim 4 wherein said body member's depending front and back edges are resiliently engaged and retained on said cupcake pan.
